(19) United States
(12) Patent Application Publication
(10) Pub. No.: US 2005/0196633 A1
(43) Pub. Date: Sep. 8, 2005

(54) Corrosion-resistant clad plate with high bonding strength and fabricating method thereof

(75) Inventors: Jung-Man Doh, Seoul (KR); Ji-Young Byun, Seoul (KR); Jin-Kook Yoon, Seoul (KR); Ju-Yong Jung, Seoul (KR)

Correspondence Address: DARBY & DARBY P.C., P. O. BOX 5257, NEW YORK, NY, 10150-5257, US

(73) Assignee: Korea Institute of Science and Technology

(21) Appl. No.: 11/024,601

(22) Filed: Dec. 29, 2004

(30) Foreign Application Priority Data
Mar. 6, 2004 (KR) 2004-0015307

(51) Int. Cl. B32B 5/18

(52) U.S. Cl. 428/615

(57) ABSTRACT

Corrosion resistant multi-layered clad plates or sheets with high bonding strength is disclosed. According to the present invention, clad metals with high corrosion resistance such as Ti, Nb, V, or Zr and their alloys can be bonded with a cheap substrate such as Fe, Cu, or Ni and their alloys by the resistance seam welding. Using the insert metal causing the eutectic reaction, the clad metal can be strongly bonded with the substrate. Especially, corrosion resistant clad plates with excellent bonding strength can be fabricated by controlling the thickness and the microstructures of the eutectic reaction layer at the interface between the clad metal and the substrate or between the clad metal and the insert metal.

### BACKGROUND OF THE INVENTION

1. Field of the Invention

The present invention relates to clad plates (or sheets) with an excellent corrosion resistance property and high bonding strength, and a fabricating method thereof.

2. Description of the Background Art

Clad plate (or sheet) consists of two layers of a clad metal/a substrate or three layers of a clad metal/an insert metal/a substrate, or more than three layers of a clad metal/insert metals/a substrate. The clad metal protects the substrate from the environment such as corrosion, chemicals, heat, wear, etc. The substrate (a base metal) provides enough mechanical properties to support the building structures. In general, the thickness of the clad metal is in the range of 5% and 50% of that of the substrate.

For corrosion-resistant clad plates, the clad metal can be selected among the following materials due to their excellent corrosion resistance; stainless steels, Ni, Ni alloys, Co, Co alloys, Ti, Ti alloys, Ta, Ta alloys, Nb, Nb alloys, V, V alloys, Zr, and Zr alloys. The substrate can be selected among the Fe, Fe alloys, Cu, and Cu alloys which have enough mechanical properties for constructing a structure. The corrosion-resistant clad plates are used as a core material for heat exchangers, reaction vessels for chemical plants, ships, paper industries, constructions, bridges, pressure vessels, desalination and electric facilities, flue gas desulfurization plants, etc.

The clad plates or sheets have been fabricated mainly by a roll bonding, an explosive welding, a spot welding, a resistance seam welding process, and a brazing. Among these methods, the resistance seam welding is known to be the most economic method for fabricating the large-area clad plates or sheets. The explosive welding, the roll bonding, the spot welding, the resistance seam welding, and the brazing processes have the following advantages and disadvantages.

The explosive welding: The substrate and the clad metal are bonded within a short time by an explosive energy of a gunpowder. The insert metal layer is not needed and the explosive welding method gives the most excellent bonding strength. However, a fabricating cost is expensive, a factory installation site is limited by a loud explosive noise generated at the time of the gunpowder explosion, and it is impossible to fabricate a large-sized sheet and a thin sheet. Also, when a thin substrate is used, the substrate can be distorted by an explosive force of the gunpowder, thereby lowering ductility.

The roll bonding: The roll bonding, in which the substrate and the clad metal are bonded using a rolling mill, can fabricate the large clad plates or sheets cheaply. However, it requires an expensive installation cost (the rolling mill and a vacuum furnace, etc.). Also, because the bonding is performed at a high temperature, the brittle carbides and intermetallic compounds can be easily generated at the interface between the substrate and the clad metal.

The spot welding: Since much time is required to bonding between the clad metal and the substrate, the spot welding is mainly used for fabricating a small sheet. Other disadvantages thereof are a low bonding strength and an incomplete sealing between the clad metal and the substrate.

The brazing: The layered plates including a filler metal inserted between the clad metal and the substrate are put into a furnace and are heated at a high temperature over the melting point of the filler metal under vacuum or inert conditions. Thus, it needs much time for bonding and is difficult to fabricate the large-sized plates or sheets.

The resistance seam welding: Since the substrate and the clad metal are placed between two electrodes and then an electric current and a pressure are simultaneously applied to the electrodes to bond the substrate and the clad metal within a short time, a bonding portion is scarcely oxidized. Also, the large-seized clad plates or sheets of a cylindrical shape and a rectangular shape having an excellent bonding strength can be easily fabricated, and an installation cost and a fabricating cost are the cheapest.

In the conventional processes for fabricating the clad plates or sheets, the clad metal and the substrate are directly bonded at a high temperature or at a high temperature and pressure. Accordingly, in case of Ti which is hardly bonded to the different metals, the interface between titanium and other metal is imperfectly joined or the brittle intermetallic compounds are formed at the interface between titanium and other metal. Therefore the bonding strength of the clad plates or sheets becomes low. In this invention to solve such the existing drawbacks, a low melting eutectic reaction between the clad metal and the substrate has been proposed. Also, another cladding technology using an insert metal layer forming eutectic reaction with clad metals such as Ti, Nb, V, Zr and their alloys has been proposed. The insert metal should be formed a low melting eutectic reaction with the clad metal or the substrate.

The proposed technology using the eutectic reaction can solve the drawbacks of the conventional processes, for example, much time required for bonding between different metals, the brittle intermetallic compounds formed at the interface between the substrate and the clad metal, the insert metal and the substrate, or the insert metal and the clad metal, and low bonding strength of the clad plates or sheets.

### SUMMARY OF THE INVENTION

An objective of the present invention is to provide corrosion-resistant clad plates and/or sheets with high bonding strength between the clad metal and the substrate.

Another objective of the present invention is to provide a fabricating method of the clad plates and/or sheets using an insert metal between the clad metal and the substrate, in which an excellent bonding can be performed within a short time by a low melting eutectic reaction and thereby a fabricating cost can be reduced.

Still another objective of the present invention is to improve a bonding strength of a clad metal to a substrate by controlling and optimizing the thickness and the microstructure of the low melting eutectic reaction layer.

To achieve these and other advantages and in accordance with the purpose of the present invention, as embodied and broadly described herein, there is provided corrosion resistant clad plates, comprising: a substrate composed of one selected from the group consisting of Cu, Cu alloy, Fe, Fe alloy, Al, Al alloy, Ni and Ni alloy; a clad metal stacked on one side or both sides of the substrate, said clad metal being composed of one selected from the group consisting of Ti, Ti alloy, V, V alloy, Nb, Nb alloy, Zr and Zr alloy; and an eutectic reaction layer formed at an interface between the substrate and the clad metal, for bonding the substrate and the clad metal, wherein intermetallic compounds are discontinuously dispersed in the eutectic reaction layer.

At least one insert metal may be inserted between the substrate metal and the clad metal, to cause an eutectic reaction with the clad metal.

Further, the present invention provides a method for fabricating corrosion resistant clad plates, comprising: preparing a stacked plates of a substrate and a clad metal, said substrate being composed of one selected from the group consisting of Cu, Cu alloy, Fe, Fe alloy, Al, Al alloy, Ni and Ni alloy and said clad metal being composed of one selected from the group consisting of Ti, Ti alloy, V, V alloy, Nb, Nb alloy, Zr and Zr alloy; inserting the stacked plates into a resistance seam welder; and applying simultaneously electric current and pressure to electrodes of the resistance seam welder to form an eutectic reaction layer at the interface between the substrate and the clad metal, wherein said eutectic reaction layer has a composite structure of intermetallic compounds with high hardness being dispersed in a matrix solid solution with high ductility.

By controlling the processing parameters, the thickness and the microstructures of the eutectic reaction layer formed at the interface between the clad metal and the substrate or between the clad metal and the insert metal is properly controlled to enhance the bonding strength of corrosion resistant clad plates.

The foregoing and other objectives, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a schematic sectional view showing a structure of one-sided clad plates according to the present invention;

FIG. 1B is a schematic sectional view showing another structure of one-sided clad plates according to the present invention;

FIG. 1C is a schematic sectional view showing still another structure of one-sided clad plates according to the present invention;

FIG. 1D is a schematic sectional view showing a structure of both-sided clad plates according to the present invention;

FIG. 1E is a schematic sectional view showing another structure of both-sided clad plates according to the present invention;

FIG. 1F is a schematic sectional view showing still another structure of both-sided clad plates according to the present invention;

FIG. 2A is microstructure of the cross-section of Ti/Ni/Fe clad plates fabricated by the present invention;

FIG. 2B is microstructure of the cross-section of Ti/Cu/Fe clad plates fabricated by the present invention;

FIG. 2C is microstructure of the cross-section of Ti/Cu/Ni/Fe clad plates fabricated by the present invention;

FIG. 2D is microstructure of the cross-section of Ti/amorphous alloy/Ni/Fe clad plates fabricated by the present invention;

FIG. 3 shows the variance of shear strength of Ti clad plates according to applied current;

FIGS. 4A to 4D shows the micro structure of the eutectic reaction layer according to the applied current;

FIG. 5 is microstructure of the cross-section of Ti clad plates fabricated according to the conventional brazing method; and

FIG. 6 is a schematic view illustrating the microstructure of the eutectic reaction layer.

### DETAILED DESCRIPTION OF THE PREFERRED EMBODIMENTS

Reference will now be made in detail to the preferred embodiments of the present invention, examples of which are illustrated in the accompanying drawings.

In the corrosion resistant clad plates or sheets, another metal called as insert metal, which result in a low melting point eutectic reaction, are inserted to an interface between the clad metal and the substrate to efficiently bond the clad metal and the substrate. Occurrence of the eutectic reaction helps the clad metal quickly (within 0.005 to 10 sec.) bond to the substrate through the insert metal. In the present invention, the eutectic reaction can occur at the interface between the clad metal and the substrate or at the interface between the clad metal and the insert metal, by simultaneously applying heat and pressure, thereby promoting to make alloying between different kind metals and obtaining excellent bonding. The insert metal inserted between the clad metal and the substrate should form eutectic reaction with the clad metal preferably at as low temperature as possible. The insert metals can be selected variously according to the kinds of the clad metal and the substrate.

The present invention has four main characteristics.

First, structure of the clad plates or sheets has to be designed to induce an eutectic reaction at the interface between the clad metal and the insert metal layer.

Second, the eutectic reaction is generated at the interface between the clad metal and the insert metal layer or at the interface between the clad metal and the substrate by properly controlling the processing parameters of the resistance seam welding.

Third, the thickness and the microstructure of the low melting eutectic reaction layer formed between the clad metal and the substrate or between the clad metal and the inserted metal are carefully controlled to improve bonding strength the corrosion-resistant clad plates and sheets.

Finally, the bonding should be finished within extremely short time, so that the brittle intermetallic compounds may not be formed at the interface between the clad metal and the insert metal.

Besides the resistance seam welding, the corrosion-resistant clad plates or sheets can be fabricated by an explosive welding, a roll bonding, or a mixing method thereof for additionally rolling the clad plates or sheets fabricated by the explosive welding process. Among these methods, the resistance seam welding has an excellent cost competitiveness since the large-sized clad plates or sheets are fabricated cheaply by the method.

A structure of the clad plates in accordance with the present invention may be a double layered structure of clad metal/substrate, or a three-layered structure of clad metal/insert metal/substrate, or a multi-layered structure of clad metal/at least two layers of insert metal/substrate or clad metal/insert metal/substrate/insert metal clad metal.

As the clad metal, Ti, Ti alloys, Nb, Nb alloys, V, V alloys, Zr, or Zr alloys are suitable. As the substrate, Fe, Fe alloys, Cu, Cu alloys, Al, Al alloys, Ni or Ni alloys are suitable. The insert metal layer placed between the clad metal and the substrate includes Co, Co alloys, Cu, Cu alloys, Fe, Fe alloys, Ni, or Ni alloys, but it is not limited to these. According to kinds of the clad metal, the insert metal layer can be differently selected. For example, amorphous alloys such as Fe-based, Cu-based, Zr-based, Ni-based, or Al-based amorphous alloys, or a filler metal such as Ag—Cu alloys, Ag—Cu—Zn alloys, Cu—Ni alloys, Cu—Zn alloys, Cu—Ni—Zn alloys, Ti—Ni—Cu alloys, etc., can also be used as the insert metal layer.

To fabricate the corrosion-resistant clad plates and sheet with an excellent bonding strength, first of all, an oxidized layer on the substrate is removed by shot-pinning or mechanical polishing, and the clad metal and the insert metal are cleaned. As one-sided stack structure (single clad) of the clad plates or sheets, the insert metal layer is pre-welded on the substrate and thereon the clad metal is stacked. In case of a both-sided stack structure (double clad), the insert metal layers are pre-welded on the both sides of the substrate and the clad metals are stacked on the insert metal layers. An electric current and a pressure are simultaneously applied to the laminated plates or sheets, thereby fabricating the multi-layered clad plates or sheets for corrosion resistance having an excellent bonding strength (on the average, more than 300 MPa).

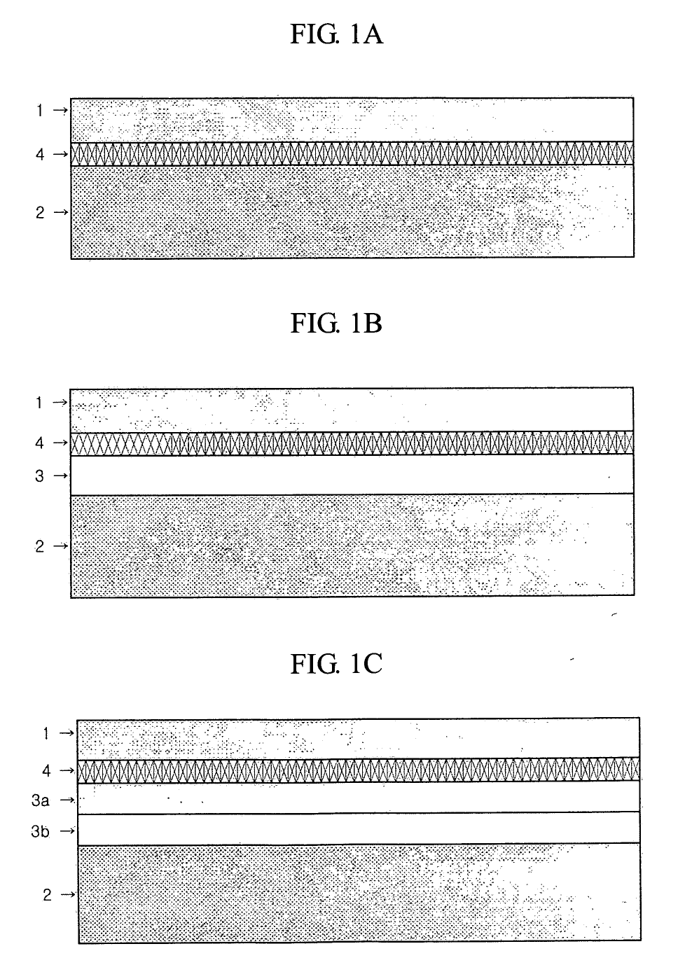

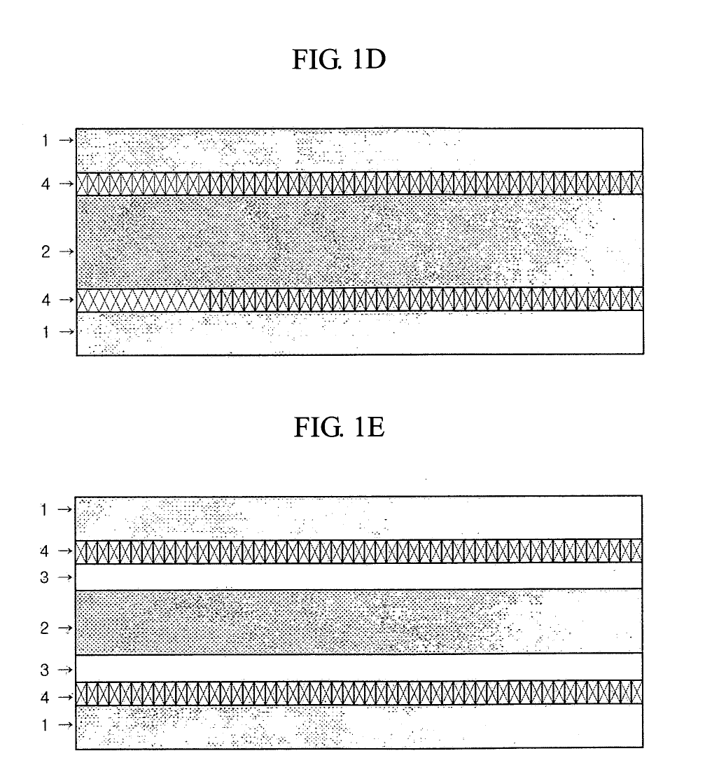

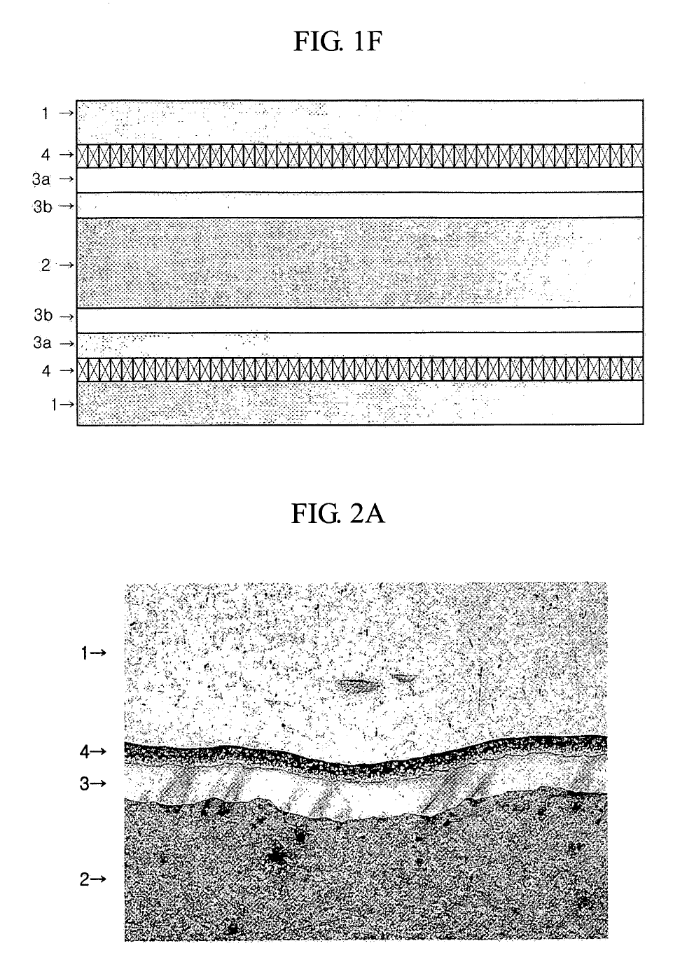

A schematic structure of the single clad plates or sheets is shown in FIGS. 1A to 1C. When the clad metal and the substrate react together to form a low-melting eutectic phase, the clad metal 1 can be directly bonded to the substrate 2 without any insert metal layer and then the eutectic reaction layer 4 is generated at the interface between the clad metal 1 and the substrate 2, thereby having a three-layered structure of the clad metal, the eutectic reaction layer, and the substrate.

In case that the clad metal and the substrate do not form eutectic reaction, as shown in FIG. 1B, the insert metal layer 3 having the eutectic reaction with the clad metal is placed to the interface between the clad metal 1 and the substrate 2, thereby having a four-layered structure of the clad metal, the eutectic reaction layer 4, the insert metal layer, and the substrate.

In the meantime, the insert metal layer placed to the interface between the clad metal and the substrate can be constructed as a multi-layered structure more than two layers. As shown in FIG. 1C, in case that the insert metal layers 3a and 3b are placed to the interface between the clad metal 1 and the substrate 2, the eutectic reaction layer 4 has to be indispensably formed at a contact part between the clad metal 1 and the insert metal layer 3a. However, the eutectic reaction layer does not have to be formed at the interface between the insert metal layer 3a and the other insert metal layer 3b and at the interface between the insert metal layer 3b and the substrate 2. The insert metal layer 3b contacted to the substrate 2 can be constructed as one layer or multi-layers more than two layers.

When the specific elements are mixed to a clad metal or a substrate, the clad metal or the substrate gets brittle, which decreases the mechanical property of the clad plate. To prevent such a drawback, the insert metal should be good affinity with the clad metal or the substrate. If an insert metal and another insert metal have poor affinity with each other, additional insert metal will be inserted between the two insert metal so as to increase the bonding strength of the clad plates. Processing parameters of the resistance seam welding should be properly controlled depending on the kinds of the clad metal and the substrate, the thickness of the respective layers of the clad plates, the presence of the insert metal, and so on.

FIGS. 1D to 1F show schematic views of the double (both-sided) clad plates or sheets. When the clad metal and the substrate react together to form a low-melting eutectic phase, the clad metals 1 are directly bonded to the substrate 2 without any insert metal layer and then the eutectic reaction layers 4 are generated at the two interfaces between the clad metals 1 and the substrate 2, thereby having a five-layered structure of the clad metal, the eutectic reaction layer, the substrate, the eutectic reaction layer, and the clad metal.

In case that the clad metal and the substrate do not react each other, as shown in FIG. 1E, the insert metal layers 3 having the eutectic reaction with the clad metal are placed to the two interface between the clad metals 1 and the substrate 2, thereby having a seven-layered structure of the clad metal 1, the eutectic reaction layer 4, the insert metal layer 3, and the substrate 2, the insert metal layer 3, the eutectic reaction layer 4, the clad metal 1.

Also in the double (both-sided) clad plates, the insert metal layer can be constructed as a multi-layered structure more than two layers. As shown in FIG. 1F, in case that the insert metal layers 3a and 3b are placed to the interface between the clad metal 1 and the substrate 2, the eutectic reaction layer 4 has to be indispensably formed at a contact part between the clad metal 1 and the insert metal layer 3a. However, the eutectic reaction layer is not necessarily at the interface between the insert metal layer 3a and the other insert metal layer 3b and at the interface between the insert metal layer 3b and the substrate 2. The insert metal layer 3b contacted to the substrate 2 can be constructed as one layer or multi-layers more than two layers.

The processing conditions of the resistance seam welding for the multi-layered clad plates (or sheets) are summarized as follows:
a size of the substrate (length×width×thickness): 6000×1500×(1˜25)mm
a size of the clad metal (length×width×thickness): 6000×1500×0.5×3.0) mm
a size of the insert metal layer (length×width×thickness): 6000×(15˜50)×(0.01˜0.15)mm
electric current: 7000˜50000 A
welding time: 0.00110 sec
cooling time: 0.00110 sec
applied pressure: 1˜200 MPa
kinds of electrode: Cu or Cu alloys
electrode thickness: 5˜30 mm
welding speed: 100˜10000 mm/min

To fabricate the corrosion-resistant clad plates (or sheets) with an excellent bonding strength by the resistance seam welding process, the above processing factors such as applied current, welding time, cooling time, applied pressure, and welding speed should be properly controlled. Moreover, the insert metal should be properly selected to form a eutectic reaction layer. If the processing factors and the insert metal are not properly selected, the clad metal and the substrate can not be perfectly bonded or may be severely damaged at the contact part thereof.

In the present invention, the eutectic reaction is occurred at the interface between the clad metal and the substrate or the clad metal and the insert metal layer to bond the different metals, so that the insert metal layer contacted to the clad metal has to be pure metals or alloys thereof which causes the eutectic reaction with the clad metal. The insert metal layer may be suitably selected depending on the kinds of the metal to be bonded. The following metals can be usually selected as the insert metal layer: Ni, Ni alloys, Co, Co alloys, Cu, Cu alloys, Fe, Fe alloys, Fe-based amorphous alloys, Cu-based amorphous alloys, Zr-based amorphous alloys, Ni-based amorphous alloys, Al-based amorphous alloys, Ag—Cu alloys, Ag—Cu—Zn alloys, Cu—Ni alloys, Cu—Zn alloys, Cu—Ni—Zn alloys, Ti—Ni—Cu alloys, etc.

Hereinafter, the present invention will be explained with the preferred examples.

### EXAMPLE 1

### Corrosion-Resistant Clad Plates (or Sheets)

Since Cu (pure Cu or a Cu-alloy) and Ni (pure Ni or a Ni-alloy) react with Ti to form a low-melting eutectic phase, one of them or a stack of the Cu and Ni sheets was inserted to an interface between the Ti (pure Ti or a Ti-alloy) and the substrate (Fe, a Fe-alloy, Cu, a Cu-alloy, Ni, or a Ni-alloy). Then, by using the resistance seam welding machine, the multi-layered clad plates (or sheets) were fabricated.

Thusly fabricated single (one-sided) clad plates (a Ti being claded on one side of a Fe substrate) has a three-layered structure including one insert metal, such as Ti clad layer/Ni insert layer/Fe substrate or Ti clad layer/Cu insert layer/Fe substrate, or a four-layered structure including two insert metals, such as Ti clad layer/Ni insert layer/Cu insert layer/Fe substrate or Ti clad layer/Cu insert layer/Ni insert layer/Fe substrate. In the present example, Ni indicates a Ni pure metal or a Ni-base alloy, and Cu indicates a Cu pure metal or a Cu-base alloy.

Meanwhile, double (both-sided) clad plates (Ti being claded on both sides of a Fe substrate) has a five-layered structure, such as Ti clad layer/Ni insert layer/Fe substrate/Ni insert layer/Ti clad layer or Ti clad layer/Cu insert layer/Fe substrate/Cu insert layer/Ti clad layer, or a seven-layered structure, such as Ti clad layer/Ni insert layer/Cu insert layer/Fe substrate/Cu insert layer/Ni insert layer/Ti clad layer or Ti clad layer/Cu insert layer/Ni insert layer/Fe substrate/Ni insert layer/Cu insert layer/Ti clad layer.

In the present example, Ni or Cu was selected as an insert metal for a low-melting eutectic reaction with Ti so as to fabricate Ti clad plates under lower temperature than the melting point thereof. As processing factors, applied electric current was 7-30 kA, applied pressure was 1-200 MPa, welding time was 0.01-10 sec, cooling time was 0.001-10 sec, and welding speed was 100-10000 mm/min.

The bonding strength of the clad plates with structure of Ti clad layer/Ni insert layer/Fe substrate or Ti clad layer/Ni insert layer/Fe substrate/Ni insert layer/Ti clad layer was 200-340 MPa. The clad plates with structure of Ti clad layer/Cu insert layer/Fe substrate or Ti clad layer/Cu insert layer/Fe substrate/Cu insert layer/Ti clad layer showed its bonding strength of 200-250 MPa. In case of the clad plates with structure of Ti clad layer/Cu insert layer/Ni insert layer/Fe substrate or Ti clad layer/Ni insert layer/Cu insert layer/Fe substrate/Cu insert layer/Ni insert layer/Ti clad layer, the bond strength was 200-250 MPa. In addition, in case of the clad plates with structure of Ti clad layer/amorphous alloy/Ni insert layer/Fe substrate or Ti clad layer/amorphous alloy/Ni insert layer/Fe substrate/Ni insert layer/amorphous alloy/Ti clad layer, the bond strength was 200-250 MPa. From the result as above, the clad plate using only Ni as an insert layer was found to have higher bonding strength compared to those using Cu, Cu/Ni, or amorphous alloy.

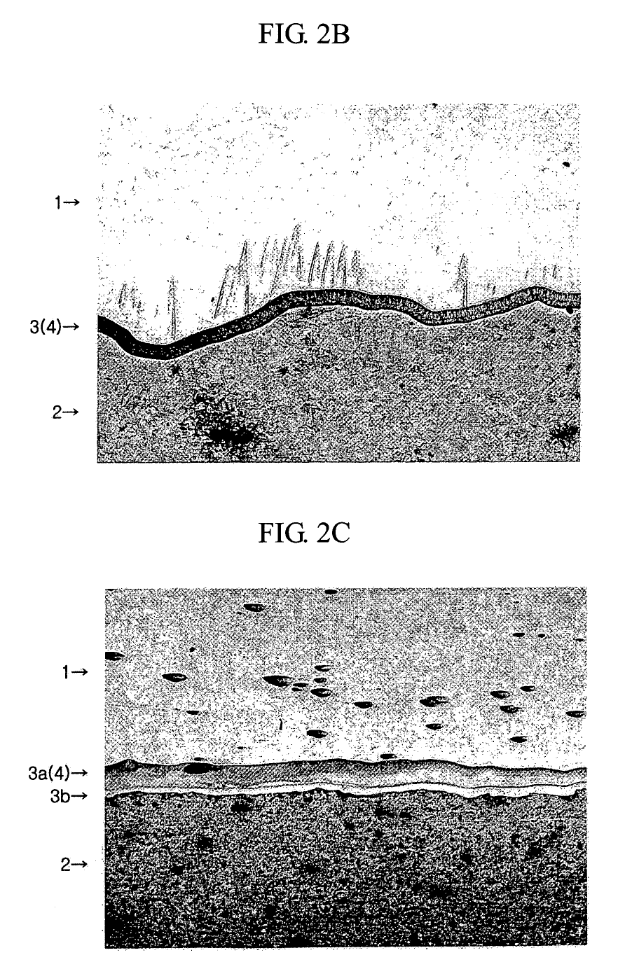

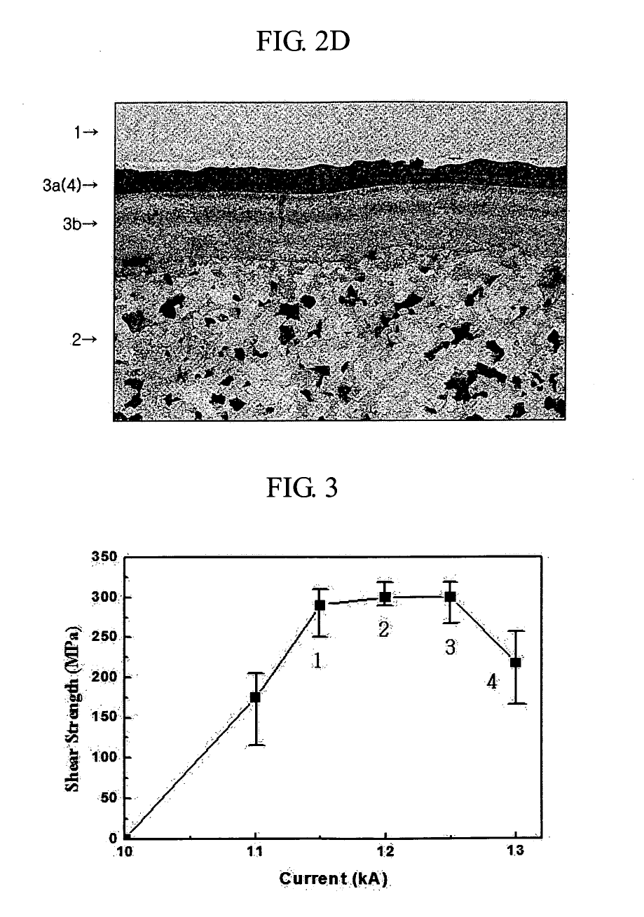

FIGS. 2A to 2D are microstructures of the cross-section of Ti/Ni/Fe clad plates, Ti/Cu/Fe clad plates, Ti/Cu/Ni/Fe clad plates, and Ti/amorphous alloy/Ni/Fe clad plates respectively fabricated according to the present invention. In the Figures, it is clearly observed that the eutectic reaction layer is formed at the interface between the Ti clad metal and the insert metal layer. It shows different microstructures from that observed in the clad plates fabricated by the conventional art. In the Ti/Cu/Fe clad plates and the Ti/Cu/Ni/Fe clad plates, due to the eutectic reaction layer, the Ti clad metal and the Cu insert metal are molten together at the interface thereof to be completely bonded with each other at the relatively low temperature of about 885° C. In the Ti/Ni/Fe clad plates and the Ti/amorphous alloy/Ni/Fe clad plates, the Ti clad metal and the Ni insert metal are molten together to be completely bonded the relatively low temperature of about 940° C.

For the Ti clad plates, other insert metal such as Ag, Ag—Cu alloys, Ag—Cu—Ni alloys, Ti—Cu—Ni alloys, Ti—Zr—Cu—Ni alloys, Fe-based amorphous alloys, Cu-based amorphous alloys, Zr-based amorphous alloys, Ni-based amorphous alloys, or Al-based amorphous alloys can be used.

### EXAMPLE 2

### Corrosion-Resistant Clad Plates (or Sheets) with Higher Bonding Strength

Since it has been found from Example 1 that Ni is most preferable as an insert metal for high bonding strength of Ti clad plates, Ni was selected to be inserted to the interface between the Ti (pure Ti or a Ti-alloy) and the substrate (Fe, a Fe-alloy, Cu, a Cu-alloy, Ni, or a Ni-alloy). Then, by using the resistance seam welding, the multi-layered clad plates (or sheets) were fabricated. The processing factors are as follows: applied electric current was 5-50 kA, applied pressure was 1-200 MPa, welding time was 0.001-1 sec, cooling time was 0.001-1 sec, and welding speed was 500-10000 mm/min. In the present Example, the welding time and the cooling time were limited to less than 1 sec, so that the brittle intermetallic compounds may not be generated at the interface of the clad metal and the substrate or the clad metal and the insert metal.

Thusly fabricated clad plates has a structure of Ti/eutectic layer/substrate, Ti/eutectic layer/substrate/eutectic layer/Ti, Ti/eutectic layer/insert layer/eutectic layer/substrate, or Ti/eutectic layer/insert layer/substrate/insert layer/eutectic layer/Ti.

FIG. 3 shows the variance of bonding strength (shear strength) of Ti clad plates according to applied current under the above processing conditions. In the Figure, it is found that increase of the shear strength increases according to the increase of the current from 10 kA to 11.5 kA, keeps constant in the current range of 11.5 kA to 12.5 kA, and decreases steeply in the current of over 13 kA.

To find out the relationship between the bonding strength and the microstructures, the inventors observed the microstructures of the Ti clad plates fabricated under conditions 1 (11.5 kA), 2 (12 kA), 3 (12.5 kA) and 4 (13 kA) of FIG. 3. The thickness of the eutectic reaction layer at the interface between Ti and Ni insert metal were found to be 0.5, 6, 17 and 45 μm, respectively.

When the eutectic reaction layer is not formed, the bonding strength of the Ti clad plates shows a large variation from 0 to 280 MPa. In case of the thickness of the eutectic reaction layer from 0.5 to 20 μm, the bonding strength shows relatively small variation from 250 to 300 MPa. However, when the eutectic reaction layer has the thickness of 50 μm, the bonding strength decreases to 150-250 MPa and shows a relatively large variation. When the thickness of the eutectic reaction layer is about 5 μm, the bonding strength is very high, from 280 to 320 MPa, and shows the lowest variation. As a result, to obtain an excellent bonding strength, the thickness of the eutectic reaction layer formed at the interface between Ti and Ni is preferably to be controlled within between 0.1 and 20 μm, more preferably, about 5 μm.

As the applied current increases, the thickness of the eutectic reaction layer is increased. Also, the kinds and microstructures of intermetallic compounds at the interface between Ti and Ni varied with the applied current changed as follows.

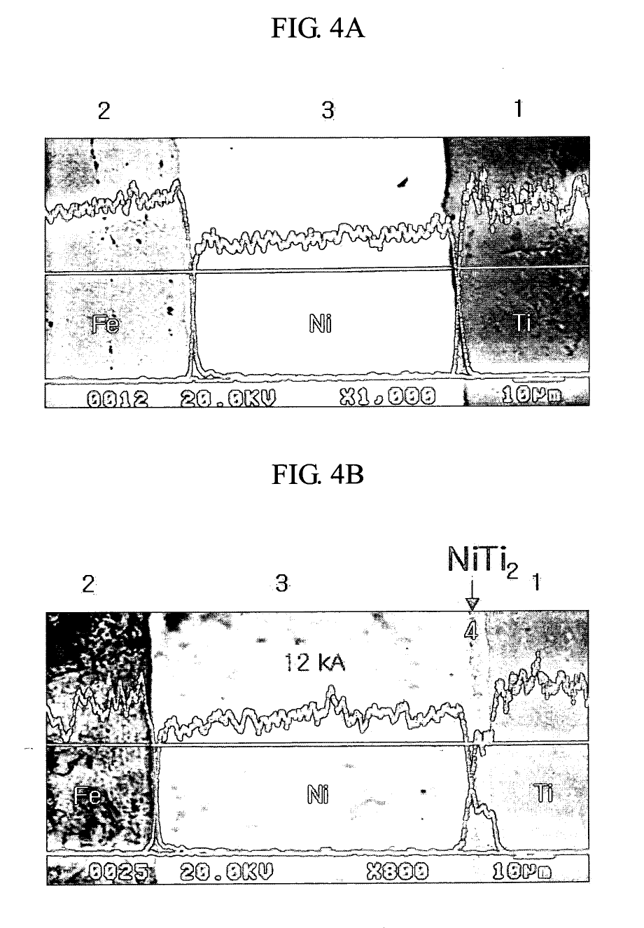

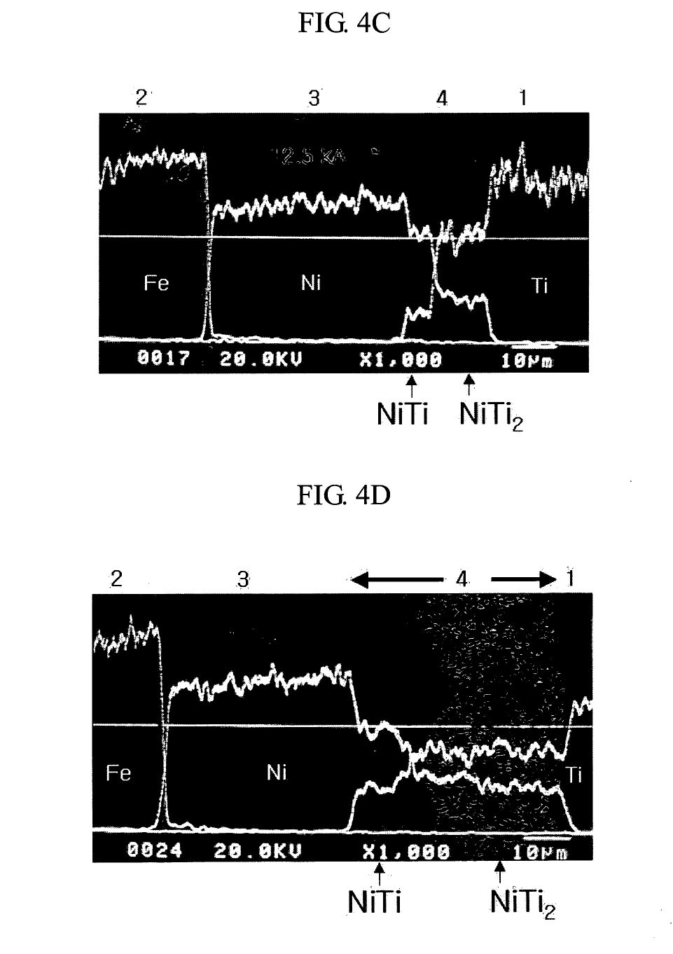

When the eutectic reaction layer is thin, the eutectic reaction layer at the interface between Ti and Ni has a composite microstructure that NiTi₂ phases are discontinuously dispersed in Ti base with small amount of Ni, as shown in FIG. 4b. When the thickness of the eutectic reaction layer reaches to about 20 μm, the microstructures of the eutectic reaction layer has a composite microstructure of discontinuously dispersed NiTi₂ phases on Ti base and NiTi intermetallic compounds discontinuously generated between Ni and NiTi₂ phases, as shown in FIG. 4c. As the applied current increases to 13.5 kA, the thickness of the eutectic reaction layer also increases over 20 μm, and the discontinuous microstructure between NiTi and NiTi₂ phases is changed into the continuous structure (refer to FIG. 4d).

From the results of FIG. 3 and FIGS. 4a to 4d, it can be understood that when the thickness of the eutectic reaction layer at the interface between Ti and Ni increases and the brittle intermetallic compounds are changed from discontinuous morphology to continuous morphology, the bonding strength of the Ti clad plates is lowered. Therefore, in order to fabricate the Ti clad plates having an excellent bonding strength, the thickness and microstructures of the eutectic reaction layer formed at the interface between Ti and Ni must be properly controlled. It is preferable to control the thickness of the eutectic reaction layer within 10 μm and to control the brittle intermetallic compounds to be discontinuously distributed in the Ni or Ti.

If the amount of the applied current is too small, the eutectic reaction layer may not be generated, which results in bonding failure. On the contrary, if the amount of the applied current is too large, the thickness of the eutectic reaction layer may exceed 20 μm, and moreover the brittle intermetallic compounds may be changed into continuous phases, which seriously reduces the bonding strength. Accordingly, in order to enhance bonding strength of the Ti clad plates, the amount of the applied current should be properly controlled to generate the eutectic reaction layer at the interface between Ti and Ni as thin as possible, so that the brittle intermetallic compounds can be discontinuously dispersed in the Ti clad metal or the Ni insert metal.

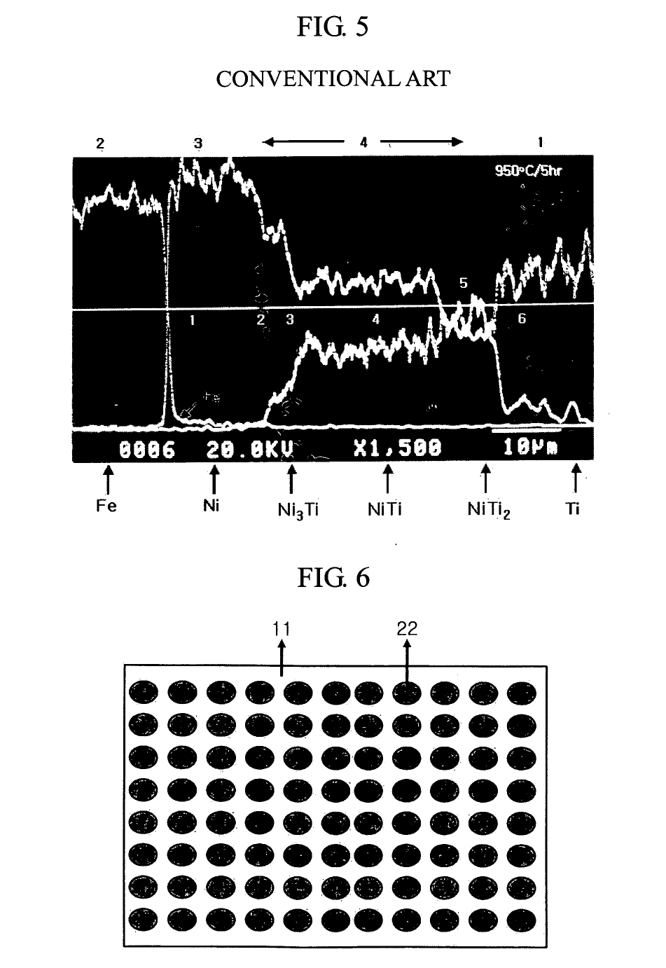

In the Ti clad plates fabricated by the conventional brazing, as shown in FIG. 5, the brittle intermetallic compounds such as NiTi₂, NiTi and Ni₃Ti are continuously at the interface between Ti and Ni, which results in reducing the bonding strength below 150 Mpa. The present invention can solves such drawbacks of low bonding strength by the conventional art.

FIG. 6 is a schematic view illustrating the microstructure of the eutectic reaction layer for embodying the Ti clad steel plates with the excellent corrosion resistance and bonding strength. Reference numeral 11 denotes a Ti—Ni solid solution, and 22 denotes brittle Ni—Ti type intermetallic compounds. The composite structure of Ni—Ti intermetallic compounds with high hardness being dispersed in high ductile Ti—Ni solid solution improves mechanical properties and ductility of the clad plates. Therefore, the Ti clad plates with the eutectic reaction layer as shown in FIG. 6 has higher bonding strength than that with the eutectic reaction layer of FIG. 5.

As a representative example in accordance with the present invention, FIG. 4B shows the composite structure of Ni—Ti intermetallic compounds with high hardness being dispersed in high ductile Ti—Ni solid solution.

The present invention provides a low cost technique to fabricate corrosion resistant clad plates or sheets. Especially, the expensive clad metals (Ti, Nb, V, and Zr) with high corrosion resistance can be bonded with the cheap Fe or Fe alloy, Cu or Cu alloy, or Ni or Ni alloy by the resistance seam welding. Comparing the conventional art, using the insert metal causing the eutectic reaction, the clad metal can be strongly bonded with the substrate. Furthermore, the corrosion resistant clad plates or sheets with bonding strength of 300 MPa can be fabricated by controlling the thickness and the microstructures of the eutectic reaction layer formed at the interface between the clad metal and the substrate or between the clad metal and the insert metal. The clad plates with high bonding strength (average shear strength: 300 MPa) according to the present invention are expected to be widely used as a core material for advanced industrial equipments, such as heat exchangers, reaction vessels for chemical plants, ships, paper industries, constructions, bridges, pressure vessels, desalination and electric facilities, flue gas desulfurization plants, etc.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. Corrosion resistant clad plates, comprising:
a substrate composed of one selected from the group consisting of Cu, Cu alloy, Fe, Fe alloy, Al, Al alloy, Ni and Ni alloy;
a clad metal stacked on one side or both sides of the substrate, said clad metal being composed of one selected from the group consisting of Ti, Ti alloy, V, V alloy, Nb, Nb alloy, Zr and Zr alloy; and
an eutectic reaction layer formed at an interface between the substrate and the clad metal, for bonding the substrate and the clad metal,
wherein intermetallic compounds are discontinuously dispersed in the eutectic reaction layer.

2. The clad plates of claim 1, said clad plates has the stacked structure of clad metal/eutectic reaction layer/substrate, or clad metal/eutectic reaction layer/substrate/eutectic reaction layer/clad metal.

3. Corrosion resistant clad plates, comprising:
a substrate composed of one selected from the group consisting of Cu, Cu alloy, Fe, Fe alloy, Al, Al alloy, Ni and Ni alloy;
a clad metal stacked on one side or both sides of the substrate, said clad metal being composed of one selected from the group consisting of Ti, Ti alloy, V, V alloy, Nb, Nb alloy, Zr and Zr alloy; and
an insert metal inserted between the substrate metal and the clad metal, for causing an eutectic reaction with the clad metal;
an eutectic reaction layer formed at an interface between the insert metal and the clad metal, for bonding the insert metal and the clad metal,
wherein intermetallic compounds are discontinuously dispersed in the eutectic reaction layer.

4. The clad plates of claim 3, wherein at least one insert metal is further inserted between the insert metal and the substrate metal.

5. The clad plates of claim 4, wherein said further inserted insert metal has a higher melting point than an eutectic point of the eutectic reaction layer.

6. The clad plates of claim 3, wherein the insert metal is composed of one selected from the group consisting of Cu, Cu alloy, Fe, Fe alloy, Ni, Ni, alloy, Co, Co alloy, Ti, Ti alloy, Zr, Zr alloy, Ag, Ag alloy, Au, Au alloy.

7. The clad plates of claim 3, wherein the eutectic reaction layer formed at the interface between the clad metal and the insert metal has a composite structure of brittle intermetallic compounds with high hardness being dispersed in a solid solution with high ductility.

8. A method for fabricating corrosion resistant clad plates, comprising:
preparing a stacked plates of a substrate and a clad metal, said substrate being composed of one selected from the group consisting of Cu, Cu alloy, Fe, Fe alloy, Al, Al alloy, Ni and Ni alloy and said clad metal being composed of one selected from the group consisting of Ti, Ti alloy, V, V alloy, Nb, Nb alloy, Zr and Zr alloy;
mounting the stacked plates into a resistance seam welder; and
applying simultaneously electric current and pressure to electrodes of the resistance seam welder to form an eutectic reaction layer at the interface between the substrate and the clad metal,
wherein said eutectic reaction layer has a composite structure of intermetallic compounds with high hardness being dispersed in a solid solution with high ductility.

9. The method of claim 8, wherein applied current is from 7 to 30 kA, applied pressure is from 1 to 200 MPa, welding time is from 0.01 to 10 sec, cooling time is from 0.001 to 10 sec, and welding speed is from 100 to 10000 mm/min.

10. A method for fabricating corrosion resistant clad plates, comprising:
preparing a stacked plates of a substrate, an insert metal and a clad metal, said substrate being composed of one selected from the group consisting of Cu, Cu alloy, Fe, Fe alloy, Al, Al alloy, Ni and Ni alloy and said clad metal being composed of one selected from the group consisting of Ti, Ti alloy, V, V alloy, Nb, Nb alloy, Zr and Zr alloy, and said the insert metal being composed of one selected from the group consisting of Cu, Cu alloy, Fe, Fe alloy, Ni, Ni, alloy, Co, Co alloy, Ti, Ti alloy, Zr, Zr alloy, Ag, Ag alloy, Au, Au alloy;
mounting the stacked plates into a resistance seam welder; and
applying simultaneously electric current and pressure to electrodes of the resistance seam welder to form an eutectic reaction layer at the interface between the substrate and the clad metal,
wherein said eutectic reaction layer has a composite structure of intermetallic compounds with high hardness being dispersed in a solid solution with high ductility.

11. The method of claim 10, wherein applied current is from 7 to 30 kA, applied pressure is from 1 to 200 MPa, welding time is from 0.01 to 10 sec, cooling time is from 0.001 to 10 sec, and welding speed is from 100 to 10000 mm/min.
